(19) United States
(12) Patent Application Publication
(10) Pub. No.: US 2013/0228060 A1
(43) Pub. Date: Sep. 5, 2013

(54) ELECTRIC GUITAR OR BASS AND DEVICE IN CONNECTION WITH ELECTRIC GUITAR OR BASS

(71) Applicants: Jan LINDÉN, Turku (FI); Olavi LINDÉN, Billnas (FI)

(72) Inventors: Jan LINDÉN, Turku (FI); Olavi LINDÉN, Billnas (FI)

(21) Appl. No.: 13/782,574

(22) Filed: Mar. 1, 2013

(30) Foreign Application Priority Data
Mar. 2, 2012 (FI) 20125232

(51) Int. Cl. G10D 3/02; G10D 1/08

(52) U.S. Cl. CPC G10D 3/02; G10D 1/08
USPC 84/267; 84/294

(57) ABSTRACT

A device for use in connection with an electric guitar or bass has one or more strings tuned for notes, the device includes a body. The device further includes two or more resonators arranged to extend from the body and vibrate in relation to the body at the frequencies of the notes.

### FIELD OF THE INVENTION

The present invention relates to a device for use in connection with an electric guitar or bass and especially to a device as defined in the preamble of independent claim 1. The present invention further relates to an electric guitar or bass and more particularly to an electric guitar or bass as defined in the preamble of independent claim 13.

### BACKGROUND OF THE INVENTION

Electric guitars and basses comprise normally a body, a neck extending from the body, a headstock provided to the distal end of the neck and one or more strings held in tension over at least part of the body and the neck from the body to the headstock. The neck of the electric guitar or bass starts to vibrate when the electric guitar or bass is played. This vibration of the neck provides a negative effect such that some tones do not sustain well when played. These tones are commonly called as dead spots. The cause of the dead spots is the second mode of vibration or resonance of the guitar or the neck of the guitar. This corresponds the second mode of vibration or resonance of a bar. When the frequency of the played tone coincides with the resonance frequency of the second mode of vibration of the guitar or the neck and body of the guitar the energy of the string will be rapidly consumed resulting in the mentioned dead spot.

In prior art the problem relating to the dead spots is tried to overcome by adding weight to the instrument and specifically to the neck or headstock of an electric guitar or bass. Another prior art solution for overcoming the problems relating the dead spots is stiffening neck of the electric guitar or bass. The stiffening is carried out form example by coating or providing the neck with one or more carbon fibre layers. The prior art solutions also comprise some basic vibrator assemblies provided to an electric guitar and bass for reducing the vibration of the neck.

The problem relating to the prior art solutions for overcoming the problems relating to dead spots is that the they do not remove or reduce the dead spots but only shift the resonance frequency and thus the location of the dead spots. Adding extra weight to the instrument lowers the resonance frequency of the guitar or the body and neck of the guitar. On the other hand stiffening the neck of the instrument raises the resonance frequency. Therefore, the prior art s do not remove or reduce the problem relating to the dead spots but only changes the tones which are subjected to the dead spots and poor sustain. The known vibrators only slightly generally resonance of the neck without solving the problem relating to the sustaining of notes.

### BRIEF DESCRIPTION OF THE INVENTION

The object of the present invention is to provide a device so as to overcome or at least alleviate the prior art disadvantages. The objects of the present invention are achieved with a device according to claim 1. The objects of the present invention are further achieved with an electric guitar and bass according to claim 13.

The preferred embodiments of the invention are disclosed in the dependent claims.

The present invention is based on the idea of providing a device having a body and two or more resonators or vibration tongues arranged to extend from the body and vibrate in relation to the body at the frequencies of the notes. The two or more resonators are arranged to extend freely from the body for enabling vibration in relation to the body. The resonators comprise a weight member and a tongue rod provided to extend from the body. The weight member is preferably provided to the distal end of the tongue rod such that the tongue rod forms a spring element for vibrating the weight member in relation to the body. The device may be attached to an electric guitar or bass for eliminating or at least reducing the dead spots. It should be noted that the resonators or vibration tongues may be any type of resonators which may vibrate relative to the body or the neck of the electric guitar or bass.

In one embodiment the resonators are provided to an electric guitar or bass. This means that the device as described above may be attached, engaged or connected to an electric guitar or bass, especially to a neck or headstock of the electric guitar or bass, or alternatively the resonators are formed, provided or connected directly to the neck or headstock of the electric guitar or bass. The resonators or the device is connected to the electric guitar or bass such that the vibration tongues may vibrate in relation to the neck when the guitar or bass in played.

The present invention has the advantage that when resonators are tuned to the frequency of the notes they vibrate in anti-phase with the neck and prevent neck from vibrating. Therefore, vastly improved sustain of the notes is achieved. The reduced vibrations of the neck and the electric guitar or bass results in enhanced sustain of notes and tones. Furthermore, the device of the present invention may be connected detachably to the instrument such that no permanent installations or amendments to the instrument have to be made.

### BRIEF DESCRIPTION OF THE FIGURES

In the following the invention will be described in greater detail, in connection with preferred embodiments, with reference to the attached drawings, in which

FIG. 1 is a general view of an electric guitar;

FIG. 2 shows schematically the principle of vibrations of an electric guitar or bass;

FIGS. 3A, 3B and 3C show schematically one embodiment of the device according to the present invention;

FIGS. 4A, 4B and 4C show schematically another embodiment of the device according to the present invention;

FIGS. 5, 6, 7 and 8 show the device of FIG. 3 provided to a headstock of electric guitars;

FIG. 9A and 9B illustrate the operation of the device of the present invention.

### DETAILED DESCRIPTION OF THE INVENTION

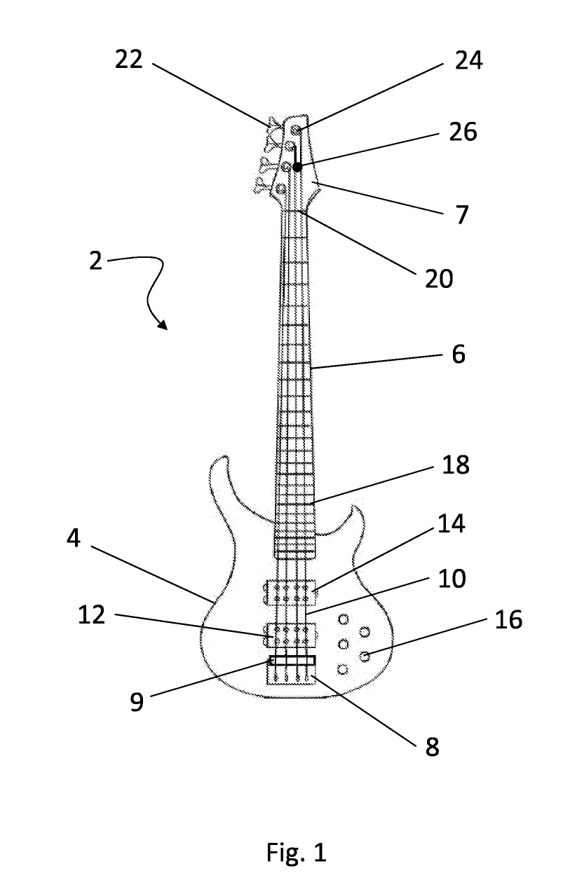

The FIG. 1 shows schematically a conventional electric guitar 2. The electric guitar 2 comprises a body 4, a neck 6 extending from the body 4 and a headstock 7 provided to the distal end of the neck and opposite end of the neck 6 in relation to the body 4. The electric guitar 2 further comprises one or more strings 10 held in tension over at least part of the body 4 and the neck 6. The body 4 is provided with a tailpiece 8 for attaching the strings 10 to the body 4. The headstock 7 is further provided with machine heads 22 connected to string cylinders 24. The strings 10 are connected to the string 10 cylinders 24 and wound around the sheath of the string cylinders 24. The strings 10 may be tightened or loosed by turning the machine heads 22 for turning the string cylinders 24 so as to adjust the tension of the strings 10. It should be noted that the headstock 7 does not have to have any special form, but it is defined as a part or extension of the neck 6 to which the strings 10 are connected. The electric guitar 2 may further be provided with at least one string retainer 26. The string retainer 26 is preferably located to the headstock 7 for keeping the strings 10 at a proper location. The string retainer 26 may be fixed to the headstock 7 or it may be a removable and movable part. In FIG. 1 the sting retainer 26 is button-like round part attached to the headstock 7.

The body 4 of the electric guitar 2 is further provided with a bridge 9 for holding the strings 10 at proper location is the body 4. The neck 6 is provided with frets 18. Frets may be are metal strips provided to the neck 6 and located at exact points that divide the scale length in accordance with a specific mathematical formula. Pressing a string 10 against a fret determines the strings' 10 vibrating length. The electric guitar 2 is further provided with a nut 20. The nut is a small strip of hard or medium-hard material located at the joint where the headstock 7 meets the neck 6. The nut 20 is provided with grooves for receiving strings 10 for guiding the strings 10 and giving consistent lateral string placement. The body 4 may further provided with one or more pickups 12, 14. Pickups 12, 14 are transducers arranged to detect string vibrations and convert the mechanical energy of the strings 10 into electrical energy. The body 4 is also provided with electronics 16 comprising potentiometers, capacitors or the like for adjusting aspects of the sound produced by the electric guitar 2.

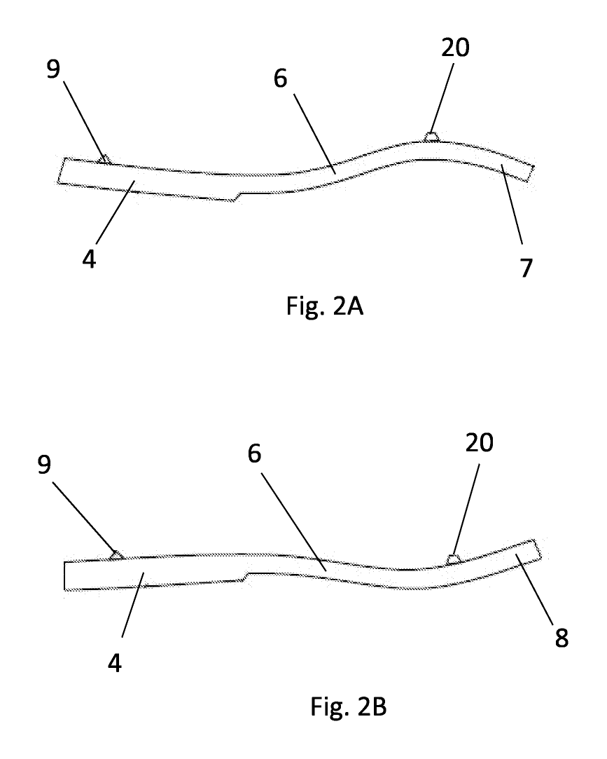

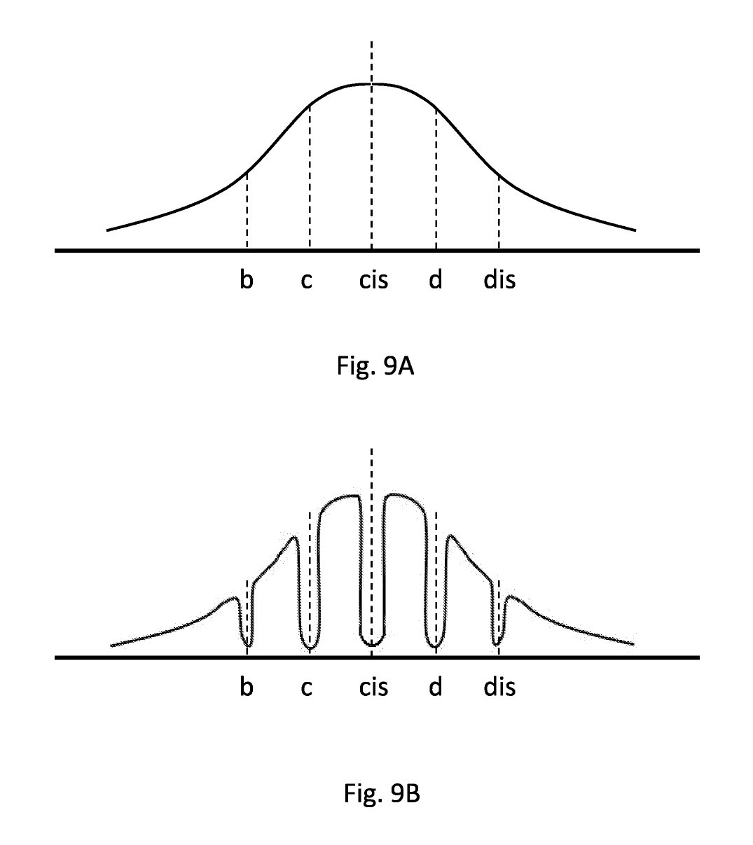

The electric guitar or bass is played the strings are vibrated causing the guitar 2 and the neck 6 of the guitar or bass 2 to vibrate. FIG. 2 shows schematically and exaggerated second mode of vibration of the electric guitar 2 and the neck 6 during playing of the guitar 2. This corresponds the normal second mode of vibration of a bar. The second mode of vibration may usually occur at resonance frequency range 130-150 Hz for electric basses and at frequency range 160-200 Hz for electric guitars. The vibration of the electric guitar or the bass 2 has the disadvantage that some tones or notes do not sustain well when played and this provides so called dead spots. The dead spots are produced when the frequency of the played tone or note and the resonance frequency of the guitar 2 coincide such that vibration energy of the strings 10 is rapidly consumed. Most bass guitars have a dead spot consisting of the notes b, c, cis, d, and dis. The neck resonance is illustrated by the curve in FIG. 9A. The inner damping of the neck material spreads the dead spot, the more damping, the wider the curve.

In the present invention the dead spots are removed or at least reduced by providing the electric guitar or bass 2 with a device comprising two or more resonators which are tuned to the notes of the instrument for reducing the vibration of the neck 6 when the strings 10 are played. The device is preferably attached or provided to the neck 6 or headstock 7 of the electric guitar or bass 2. The device may therefore comprise a separate resonator for each note suffering from short sustain. When the electric guitar or bass 2 is played the resonators will vibrate in anti-phase with the neck 6 and prevent the neck 6 from vibrating or at least reduce the vibration of the neck 6. FIG. 9B shows the effect of the resonators to the resonance of the neck. In the embodiment of FIG. 9B the device comprises 5 resonators, one for each note b, c, cis, d and dis. For example, when one resonator of the device is tuned exactly to cis note, this resonator will vibrate in anti-phase with the neck and thus from vibrating when the note cis is played. This may be seen in the curve FIG. 9B, as the resonance of the neck drops dramatically at cis. Thus the sustain of note cis is improved. To achieve an even sustain of all the notes in the dead spot area it is necessary to add similar resonators tuned to each note suffering from short sustain, as shown schematically in FIG. 9B. Thus the device may comprise one resonator for each note and drop the neck resonance curve, shown in FIG. 9B.

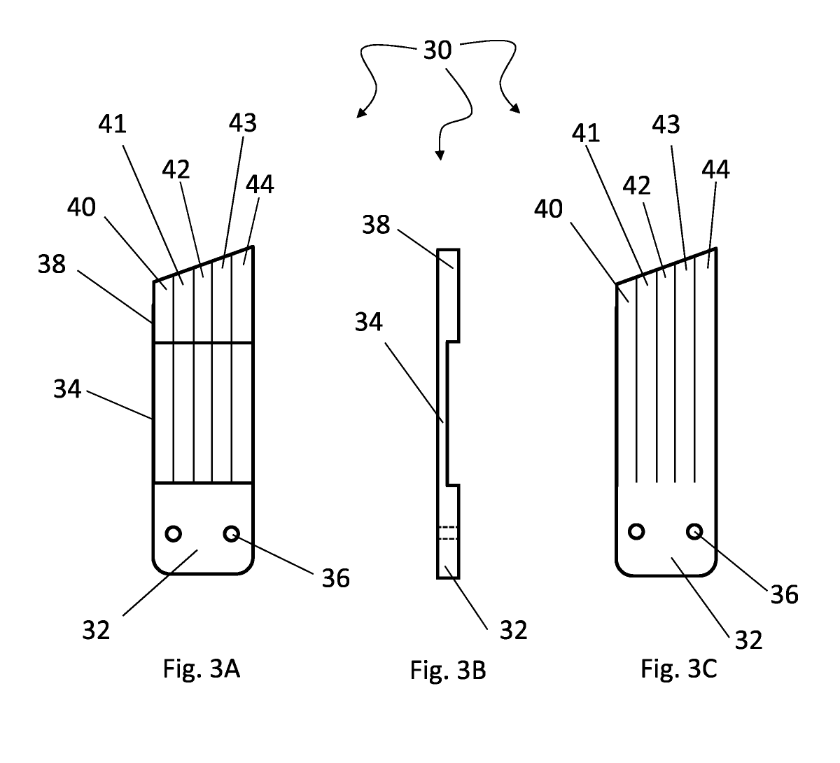

FIG. 3 shows one embodiment of the device 30 of the present invention for use in connection with an electric guitar or bass 2 having one or more strings 10 tuned for notes. The device 30 for improving sustain of notes comprises a body 32 and resonators 40, 41, 42, 43, 44 arranged to extend from the body 32 and vibrate in relation to the body 32 at the frequencies of the notes. In FIG. 3 the device 30 comprises 5 resonator or vibration tongues 40, 41, 42, 43, 44, but the device may also comprise only one resonator, preferably two or more resonators or any number of resonators suitable for a specific instrument. Usually the device 30 will comprise 5 or 6 resonators 40, 41, 42, 43, 44 according to the number of string in the electric guitar or bass 2. Thus the device 30 and the resonators 40, 41, 42, 43, 44 form a comb-like structure.

The 40, 41, 42, 43, 44 extend freely from the body 32 for enabling vibration in relation to the body 32 such that each resonator 40, 41, 42, 43, 44 may vibrate independently from others. This means that generally the resonator will vibrate when the note to which it is tuned is played.

The device 30 of FIG. 3 is formed as single piece part in which the resonators 40, 41, 42, 43, 44 are integral part of the body 32. In an alternative embodiment the resonators 40, 41, 42, 43, 44 may attached to the body 32 with suitable attachment means, such as mechanical fasteners, glue, soldering or the like. It should be noted the in the latter embodiment the neck 6 or the headstock 7 of the electric guitar or bass 2 may form the body to which the resonators are directly attached. Thus each resonator may be attached separately to the guitar or bass 2.

FIG. 3A shows a bottom view of the device 30, FIG. 3B shows a side view and FIG. 3C shows a top view of the device 30. The device 30 is plate element, to which the resonators 40, 41, 42, 43, 44 are provided by cutting such that device 30 is formed from a single material piece. The device 30 may be manufactured from hardened steel. Other materials could also be used but it is essential that the internal damping of the resonators 40, 41, 42, 43, 44 have low internal damping.

As shown in FIGS. 3A and 3B, the resonators 40, 41, 42, 43, 44 comprise a resonator rod 34 provided to extend from the body 32. The resonator rod 34 forms spring element enabling vibration of the resonators 40, 41, 42, 43, 44 in relation to the body 32. The resonator rod 34 has lower material thickness than the body 32 for enabling vibration in relation to the body 32 such that the resonator rod 34 forms the spring section of the resonator 40, 41, 42, 43, 44. In the embodiment of FIGS. 3A, 3B and 3C the resonator rod 34 is provided by machining the plate element thinner. The resonator 40, 41, 42, 43, 44 further comprises a weight member 38. The weight member 38 is provided to the distal end of the resonator rod 34, away from the body 32. The weight member 38 will provide the vibration effect together with the vibration rod 34. Accordingly the weight member 38 will vibrate at the end of the resonator 40, 41, 42, 43, 44 due to the spring effect of the vibration rod 34. The mass of the weight member 38 may be 5 g or less, preferably 3 g or less and more preferably 2 g or less. Thus, if the mass of the weight member 38 is only 2 g per note, the total weight of the device 30 is about 15 to 20 g. Therefore, the device is very light and does not disturb the player of the instrument. As shown in FIG. 3A, each resonator 40, 41, 42, 43, 44 has a slightly different size of weight member 38, but the length of the resonator rod 34 is equal. Thus in this embodiment the tuning of the resonators 40, 41, 42, 43, 44 to the notes is carried out by provided the weight members with different masses. The resonators 40, 41, 42, 43, 44 are different in length as the mass of the weight members is controlled by the length of the weight members resulting slanting end of the device 30.

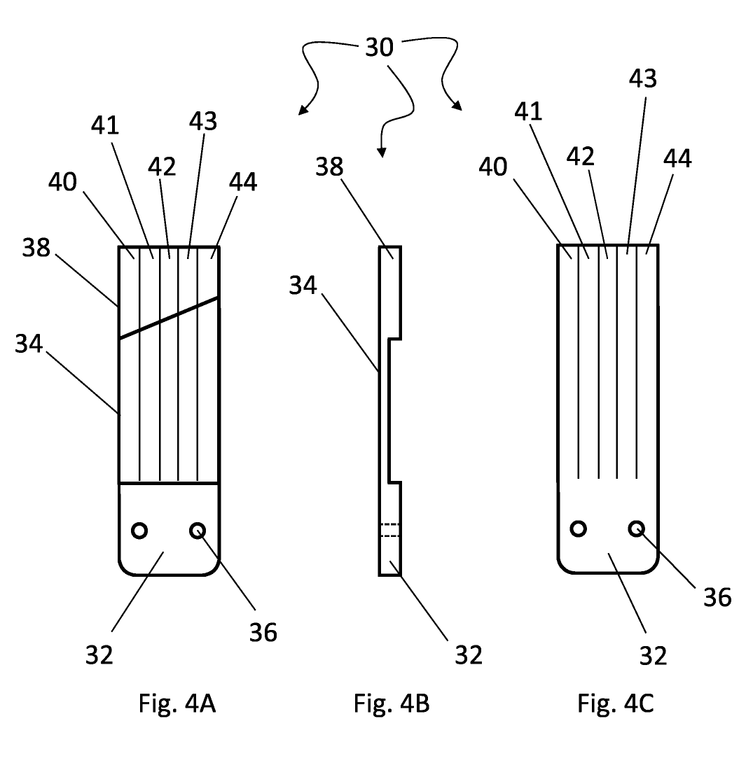

FIGS. 4A, 4B and 4C show an alternative embodiment of the device 30 in which the length of the resonator rods 34 is different for different resonators 40, 41, 42, 43, 44. The masses, and sizes, of the weight members 38 are also different and the distal end of the device 30 is straight. In an yet alternative embodiment the masses of the weight members 38 of different resonators could be equal and the tuning is only done with the length of the resonator rods 34. Accordingly, tuning of the resonators 40, 41, 42, 43, 44 to the notes of the instrument may be carried out by adjusting one or more of the following: the length and thickness of the resonator rods 34, the weight and size of the weight members 38.

The device may be arranged to be installed to the neck 6 or to a headstock 7 provided to distal end of the neck 6. The device 30 may also comprise attachment arrangement or means for attaching the device to the electric guitar or bass 2, and especially to neck 6 or headstock 7. The attachment means are formed to the body 32. In FIGS. 3A and 4A, the attachment means comprise holes 36 for attaching the device 30 with screws or some other mechanical fasteners. The device 30 may be fastened to the neck or headstock in different ways, by screw(s), bolt(s), glue, with magnet, or some type of clamp. It can also be mortised or embedded inside the neck 6 or headstock 7. Conventionally the device is attached to the outer surface the neck 6 or headstock 7.

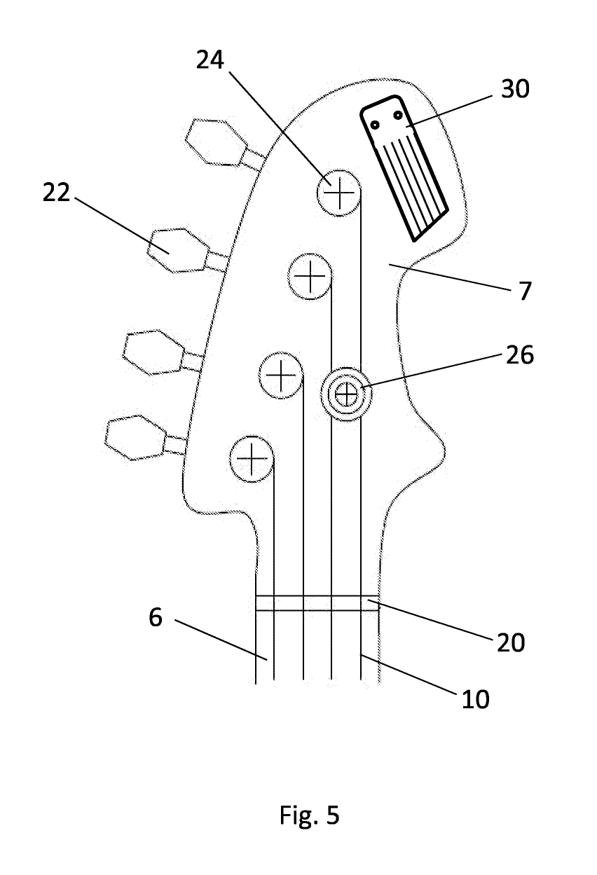

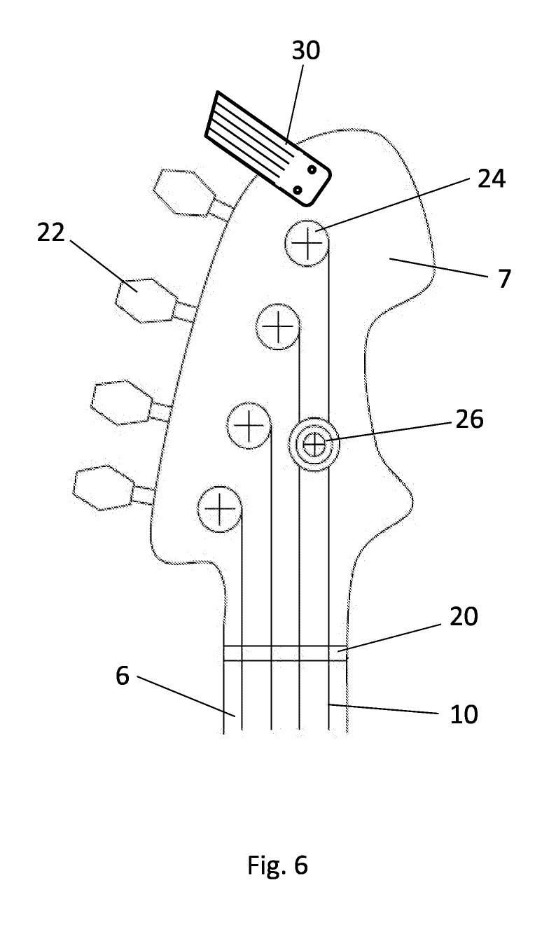

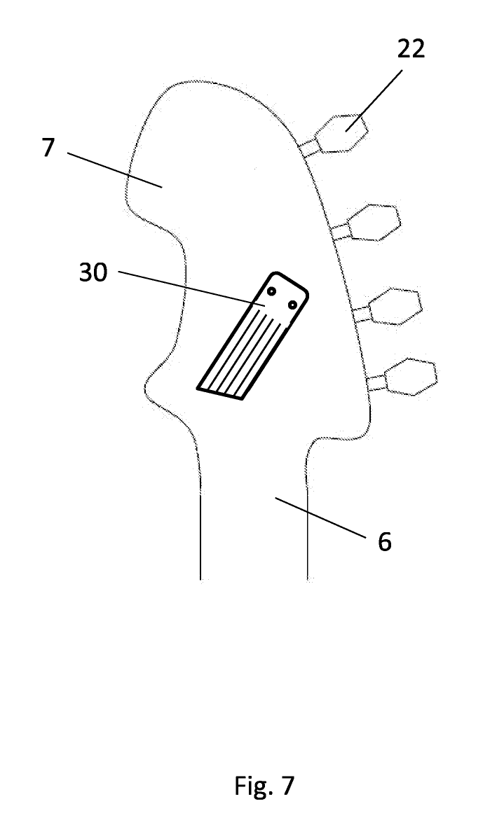

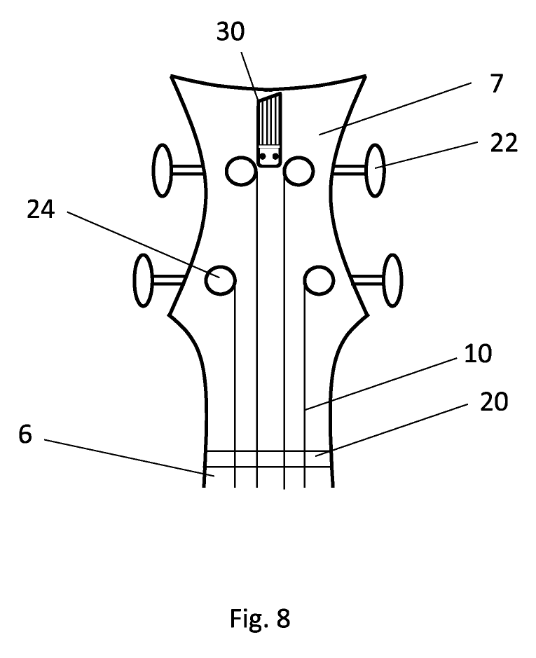

FIGS. 5, 6 and 7 show different ways and positions to which the device 30 may be installed in an asymmetric headstock 7. In FIG. 5 the device 30 is attached such that it fully over the surface of the headstock 7. In FIG. 6 the device 30 extends outside from the headstock 7. In FIG. 7 the device 30 is attached on the underside of the headstock 7. The second mode of bending of the guitar is often combined with a torsion twist. This especially found with electric guitars or basses with asymmetric arrangement of machine heads, when for example all machine heads are placed on the left side of the head, as FIG. 5. In this case it is beneficial to locate the device of the present invention to the opposite side in relation to the machine heads, thus to the right side of the headstock. FIG. 8 shows the device attached to a symmetrical headstock 7. In this embodiment the device may be attached in symmetrical location.

The present invention also provides an electric guitar or bass 2 comprising a body 4 a neck 6 extending from the body 4 and one or more strings 10 tuned for playing notes and held in tension over at least part of the body 4 and the neck 6. The electric guitar or bass 2 is provided with one or more, preferably two or more, resonators 40, 41, 42, 43, 44 arranged to extend from the neck 6 and vibrate in relation to the neck 6 at the frequencies of the notes. In a preferred embodiment the resonators 40, 41, 42, 43, 44 are provided to extend from a headstock 7 provided to the distal end of the neck 6. The vibrators are vibrators as described above. Therefore, it should be noted that the vibrators may be formed directly to the neck 6 or headstock 7 without any body 32. In this case the neck 6 or the headstock 7 forms the body of the device 30. The resonators 40, 41, 42, 43, 44 vibrate thus in relation to the neck 6. Alternatively the device 30 of the FIGS. 3A, 3B, 3B, 4A, 4B and 4C is attached to the neck 6 or headstock 7. The device 30 attached fixedly from the body 32 to the instrument such that the resonators 40, 41, 42, 43, 44 vibrate in relation to the neck 6 also in this embodiment.

The present invention further provides use of a device 30 in a neck 6 or a headstock 7 of an electric guitar or bass 2, the device 30 comprising a body 32 and two or more resonators 40, 41, 42, 43, 44 arranged to extend from the body 32 and vibrate in relation to the body 32 at the frequencies of the notes of the electric guitar or bass 2 for reducing the vibration of the neck 6 when strings 10 of the electric guitar or bass 2 are played. In other words the present invention provides use of a device 30 according above described for reducing the vibration of the neck 6 when strings 10 of the electric guitar or bass 2 are played.

It is apparent to a person skilled in the art that as technology advanced, the basic idea of the invention can be implemented in various ways. The invention and its embodiments are therefore not restricted to the above examples, but they may vary within the scope of the claims.

1. A device for use in connection with an electric guitar or bass having a body, a neck and one or more strings tuned for notes, the device comprising a body, wherein the device further comprises two or more resonators arranged to extend from the body and vibrate in relation to the body at the frequencies of the notes for reducing the vibration of the neck when the strings are played.

2. A device according to claim 1, wherein device is arranged to be installed to the neck or to a headstock provided to distal end of the neck.

3. A device according to claim 1, wherein the device further comprises an attachment arrangement for attaching the device to the electric guitar or bass.

4. A device according to claim 1, wherein the two or more resonators extend freely from the body for enabling vibration in relation to the body.

5. A device according to claim 1, wherein the two or more resonators are an integral part of the body or the two or more resonators are attached to the body.

6. A device according to claim 1, wherein the resonator comprises a resonator rod provided to extend from the body, or the resonator comprises resonator rod provided to extend from the body and having lower material thickness than the body for enabling vibration in relation to the body.

7. A device according to claim 1, wherein the resonator comprises a weight member, or the resonator comprises a weight member provided to the distal end of the resonator rod.

8. A device according to claim 7, wherein the mass of the weight member is 5 g or less, preferably 3 g or less and more preferably 2 g or less.

9. A device according to claim 1, wherein the device is plate element, to which the resonators are provided by cutting.

10. A device according to claim 9, wherein the resonator rod is provided by machining the plate element thinner.

11. A device according to claim 1, wherein the device is made of hardened steel.

12. A device according to claim 1, wherein the device comprises at least three resonators or the device comprises five or six resonators.

13. An electric guitar or bass comprising a body, a neck extending from the body and one or more strings tuned for playing notes and held in tension over at least part of the body and the neck, wherein the electric guitar or bass is provided with two or more resonators arranged to extend from the neck and vibrate in relation to the neck at the frequencies of the notes for reducing the vibration of the neck when the strings are played.

14. An electric guitar or bass according to claim 13, wherein the resonators are provided to extend from a headstock provided to the distal end of the neck.

15. An electric guitar or bass according to claim 13, wherein the resonator comprises a weight member provided at the distal end of the resonator.

16. An electric guitar or bass according to claim 13, wherein the resonator comprises a tongue rod provided to extend from the neck or headstock.

17. An electric guitar or bass according to claim 15, wherein the resonator comprises a tongue rod provided to extend from the neck or headstock, and the weight member is provided to the distal end of the tongue rod such that the tongue rod forms a spring element for vibrating the weight member.

18. An electric guitar or bass according to claim 13, wherein the two or more resonators are connected directly to the neck or headstock, or that the two or more resonators are provided to a separate device having body attached to the neck or headstock.

19. An electric guitar or bass according to claim 13, wherein the body is provided with an attachment arrangement for attaching the separate device to the neck or headstock of the electric guitar or bass.

20. (canceled)

21. A method comprising the step of using a device in a neck or a headstock of an electric guitar or bass, the device comprising a body and two or more resonators arranged to extend from the body and vibrate in relation to the body at the frequencies of the notes of the electric guitar or bass for reducing the vibration of the neck when strings of the electric guitar or bass are played.

22. A method comprising the step of using the device according to claim 1 in a neck or a headstock of an electric guitar or bass for reducing the vibration of the neck when strings of the electric guitar or bass are played.
